(19) United States
(12) Patent Application Publication
(10) Pub. No.: US 2009/0272020 A1
(43) Pub. Date: Nov. 5, 2009

(54) Bobbing waterfowl decoy

(76) Inventor: Robert G. Bill, Lyme, CT (US)

Correspondence Address: Robert G. Bill, 84 Sterling Hill Rd, Lyme, CT, 06371, US

(21) Appl. No.: 12/459,765

(22) Filed: Jul. 8, 2009

Related U.S. Application Data
(63) Continuation-in-part of application No. 11/686,558, filed on Mar. 15, 2007.

(51) Int. Cl. A01M 31/06

(52) U.S. Cl. 43/3; 43/2

(57) ABSTRACT

A floating water tight mechanical waterfowl decoy that produces a bobbing motion at the surface of the water for creating a radiating ripple pattern and a motion which also mimics a courtship behavior, both of which are effective lures for attracting waterfowl to a desired location. The waterfowl decoy includes a buoyant waterproof body to which an electric vertically reciprocating linear motion drivetrain is mounted to the bottom surface in the general head region that drives a disc shaped plunger positioned generally horizontally below the body surface. The waterfowl decoy further includes a waterproof magazine, also mounted to the bottom surface of the body generally in the posterior region behind the drivetrain, for containment of a timing/receiver circuit that controls the drivetrain and is in signal communication with a remote transmitter that functions as an ON/OFF switch. The waterfowl decoy is powered by a rechargeable battery pack also located in the magazine. The bobbing motion is produced by the up and down motion of the plunger in a dense medium such as water causing the motion to be transferred to the body. This motion, in addition to producing a visible wave train also mimics a courtship behavior making the motion and waves a very effective lure to passing waterfowl.

The present disclosure is a CONTINUATION-IN-PART for application Ser. No. 11/686,558 filed on Mar. 15, 2007.

### TECHNICAL FIELD

The present invention relates to a waterfowl decoy device generally, and specifically relates to a waterfowl decoy that generates both movement and water agitation that mimic the actions of live waterfowl.

### BACKGROUND

Waterfowl decoy devices have been in use since prehistoric times for the purpose of luring live waterfowl within range of the hunter for capture. There was very little development in decoys over the centuries other than improved morphological detail which was enhanced by the introduction of plastic molding during the 1940's. Historically it has been known that motion, which is a strong lure, can be imparted to decoys by the crude method whereby the hunter jerks on a line attached to decoys. This method is still used because it is effective in an environment where there is no water current, little floating vegetation, and a stationary hunting blind. If these conditions do not exist, the decoy may quickly become fouled in vegetation and require constant tending. This problem similarly impacts many mechanical decoys.

Because there is normally no motion or water disturbance in prior art decoy spreads, live waterfowl learn to avoid artificial decoy spreads through learning unless the hunter can employ some method to create motion, particularly late in the hunting season. This has created an impetus to develop realistic motion producing decoys to replace or supplement the string jerk method. Early inventions were crude devices, but with the advent of improved technology, the development of mechanical decoys has quickly expanded. Patents have been granted for decoys that are propelled by water pumps, sculling paddles, and propellers. Patents have also been granted for waterfowl decoy motion by moving heads, splashing paddles, splashing wings, tilting bodies and eccentric weight movement. There are also patents for waterfowl decoys with spinning wings that are mounted on stakes or floating platforms.

All the above decoy devices can be effective waterfowl lures because they produce motion, but each has deficiencies. The self propelled devices become entangled in floating vegetation and cease to function. The highly visible spinning wing variety are very effective early in the hunting season, but are learned to be avoided because the motion is recognized to be unnatural. Many of these designs are complex and delicate, and may require as much as ten minutes to assemble and deploy. Finally, none are completely waterproof. Thus there is a need for a mechanical waterfowl decoy that is durable, waterproof, easy to deploy, and produces a realistic motion, even in vegetation, that waterfowl do not become habituated against.

### SUMMARY

The disclosed invention relates to a bobbing mechanical waterfowl decoy for positioning at the water surface that produces, as a lure, highly visible ripples and mimics a documented waterfowl sexual behavior, the decoy comprising: a HDPE waterproof decoy body with a head and neck region, a front breast perimeter, and a bottom surface with a “T” shaped slot at the posterior end for attachment of a waterproof electronics magazine, and an anterior waterproof flange for attachment of a drivetrain, generally orthogonally below the head/neck region; an up and down reciprocating linear motion electric drivetrain for producing a bobbing motion of the decoy body at the water surface; and a submerged waterproof magazine for containing a central processing unit and a rechargeable power source for controlling and powering the drivetrain via a waterproof wire conduit joining the magazine to the body's bottom surface, and a removable waterproof plug for access to the magazine. The lower submerged end of the drivetrain is provided with a disc shaped plunger arranged horizontally that resists movement in water during the drivetrains up and down reciprocations, thus transferring the up and down bobbing motion to the body at the water surface. The ventral waterproof connections provided on the body surface for the submerged magazine and drivetrain, lower the decoys center of mass making it self righting and completely waterproof, and provide protection against damage from gunshot pellets. A pair of vertically moving brightly colored feet, generally submerged at the posterior end of the body to mimic swimming, may be connected to the drivetrain by a yoke and by a series of levers pivoting about a fulcrum, located centrally on the magazine, to increase visibility. The decoy may also be provided with a remote transmitter that functions as an ON/OFF switch to conserve battery power. A cleat is provided at the forward end of the decoy bottom surface for attachment of a conventional anchor line for mooring. The waterfowl decoy as described above has the advantages of being completely waterproof, self righting, resistant to damage, easy to deploy, non fouling in vegetation, highly visible, and exhibits a true waterfowl behavior that makes it an effective lure.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 shows a perspective view of the disclosed decoy;

FIG. 2 shows a top view of the disclosed decoy;

FIG. 3 shows a cross-sectional view of the disclosed decoy;

FIG. 4 shows an exploded view of the decoy assembly not including the internal drivetrain parts;

FIG. 5 shows a detailed exploded view of the drivetrain parts;

FIG. 6 shows a detailed exploded view of the drivetrain internal parts; and

FIG. 7 shows a detailed exploded view of the magazine assembly.

FIG. 8 is a perspective of the foot assembly.

### DETAILED DESCRIPTION

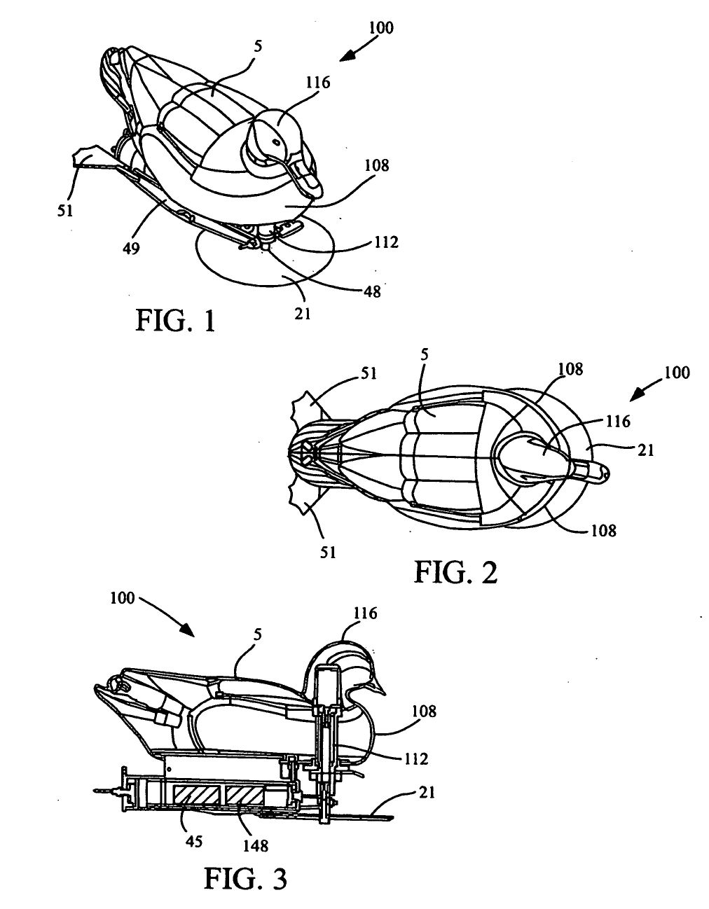

FIG. 1 of the present invention shows a perspective view 100 of a bobbing mechanical waterfowl decoy designed to be a highly visible lure to passing waterfowl. In one embodiment, the decoy 100 may use a waterproof blow molded HDPE polyethylene decoy body 5 that may be larger and not scaled to the proportions of the waterfowl species it represents for both greater visibility to passing waterfowl and greater buoyancy to support the attached drivetrain assembly 112. In other embodiments the decoy body 5 may comprise a segment of a waterfowl body it mimics. In the present embodiment, the decoy body 5 will have a head and neck region 116, a front perimeter 108, a drivertain 112 between the body 5 and a disc shaped plunger 21, and movable feet 51 connected by levers 49 to the drivetrain 112. FIG. 2 is a top view of the decoy 100. FIG. 3 is a side cross-section view of decoy 100. In this embodiment the decoy 100 mimics a mallard drake, but of course in other embodiments it may be modified to mimic other duck and goose species.

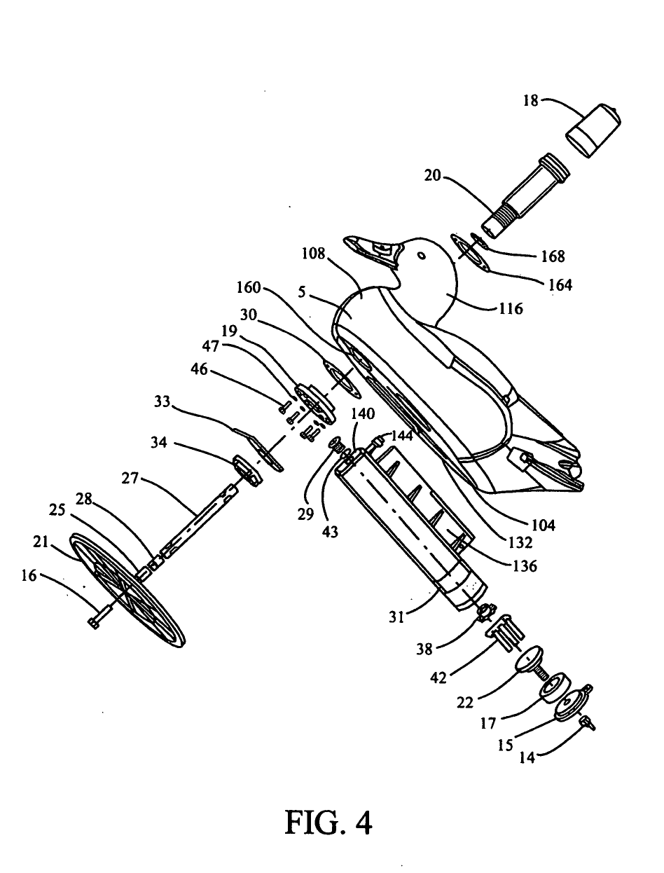

Referring now to FIG. 4, the body 5, in addition to having the head and neck region 116 and the front perimeter 108, also has a bottom surface 132. At the posterior end of the bottom surface 132, a “T” shaped slot 104 is provided for the attachment of the “T” shaped strut 136 on the HDPE magazine 31 (for housing the CPU and battery to be discussed later) with the bottom of the body 5. The plastic magazine 31 is provided with a wire conduit 144 at the foreword end of the strut that is welded with a plastic waterproof connection (not shown) to the bottom 132 of the body 5. The interior of magazine 31 is generally rectangular and transitions to cylindrical at the posterior end for accepting a round expandable waterproof plug 17 that is compressed between washers 15 and 22 when nut 14 is tightened, said plug is the only accessible external opening on the decoy 100. The front interior 140 of the magazine below the conduit 144 provides a plurality of contacts attached to a bracket 38 and held in place by a waterproof connection to screw 29 and O-ring 43, however other suitable arrangements may be used. The wire conduit 144 is a waterproof pathway for a plurality of wires (not shown) that are in electrical and signal communication between the contacts 42 and the drivetrain 112 and antenna (not shown) within the body 5 interior. The antenna is positioned close to the interior dorsal midline for good signal communication with a remote transmitter that may be used as, but not limited to, an ON/OFF switch. At the anterior bottom surface of the body 5, a hole 160 surrounded by a plurality of blind fasteners, molded into the HDPE body in a circular pattern, provides a site for mounting the drivetrain housing 20 in a generally orthogonal position below the head 116 by means of a lower flange 19, an O-ring 168, a waterproof gasket 30, and a plurality of screws 46 that create a waterproof joint between the body 5 and drivetrain 112.

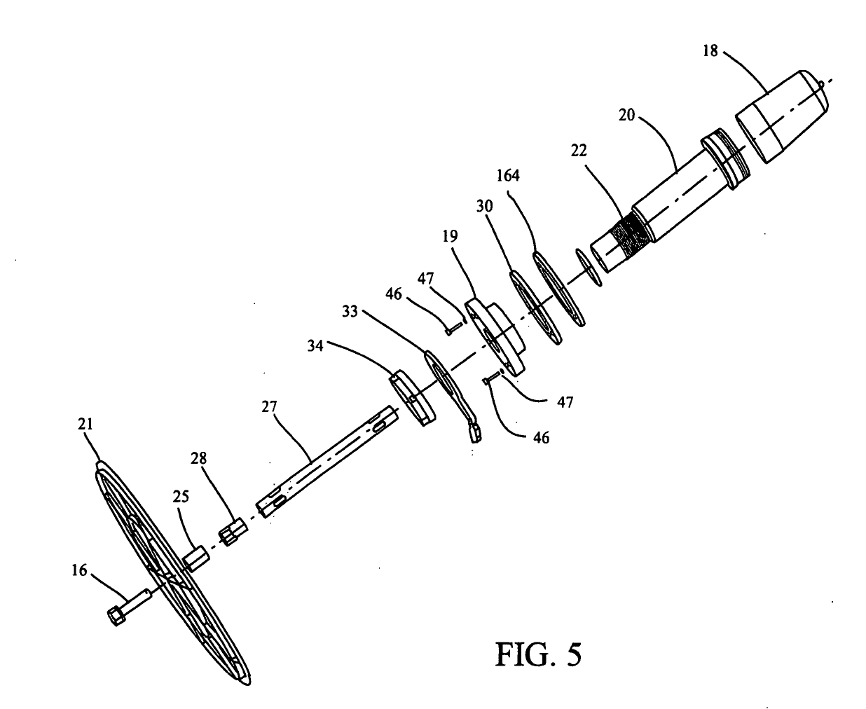

Referring now to FIG. 5, the drivetrain housing 20 and the watertight motor capsule 18 may be made of plastic. The housing 20 attaches to the lower drivetrain flange 19 by means of the lower threaded 22 portion of the housing 20, the upper housing above 22 being internal to the body in the head region 116 and the lower housing below 22 being external to the body. The threaded 22 portion of the housing 20 also provides a site for attachment of an anchor line cleat 33 and a retaining nut 34. The internal linear motion components of the drivetrain are coupled externally to the plunger assembly (16, 21, 25, and 28 to be discussed later) by a tubular coupling 27 that exits the distal end of the housing 20.

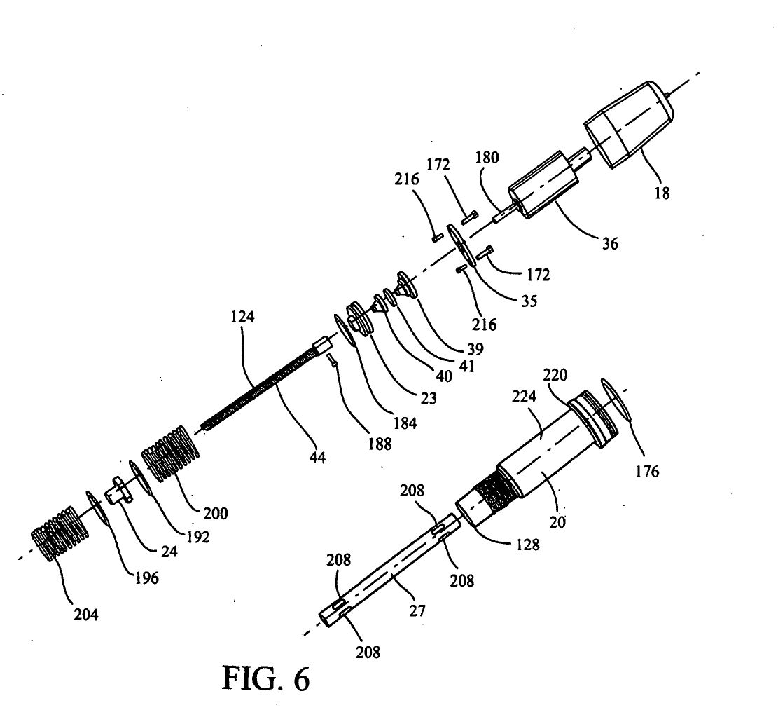

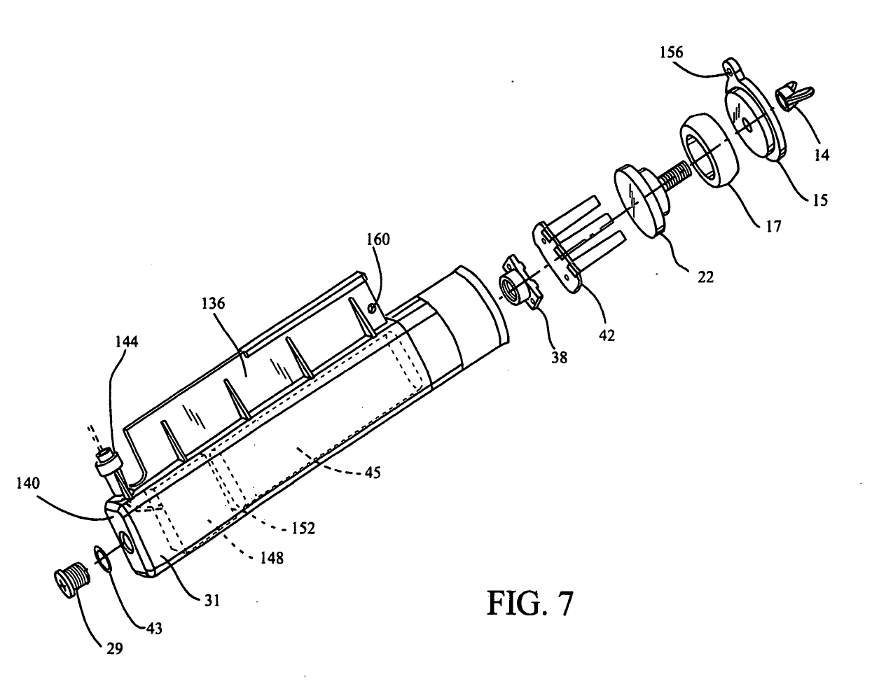

Referring now to FIG. 6, the drivetrain 112 (FIG. 3) is driven by a reversible electric motor 36. The reversible motor may be a 5.500 RPM, 9.6 VDC, or of any other suitable speed and voltage needed to give brisk movement to the drivetrain. The motor 36 attaches to the upper housing flange 220 of the drivetrain housing 20 by means of the adapter plate 35 which may be made of aluminum or any suitable material, and a plurality of screws 172. Holes (not shown) fitted with O-rings are located in the housing flange 220 and the adapter plate 35 that provide a waterproof pathway for a plurality of wires that are in electrical communication between the motor 36 and the magazine contacts 42. A capsule 18 surrounding the motor 36 and an O-ring 176 provide a watertight seal that protect the motor against water which may enter the hollow body 5. The capsule 18 may be oil filled as a further precaution. The motor shaft 180 is made of a rust proof material such as but not limited to stainless steel, and passes through 2 cone shaped neoprene seals 39 and 40, separated by a spacer 41. The seals are contained within a plastic seal holder 23 and an O-ring 184 that mount within a pocket in the top flange 220 and provide a watertight barrier between the cylindrical interior drivetrain housing which is open to the exterior environment, and the motor 36 which is isolated from the exterior by said seals. The distal portion of the motor shaft 18, after passage though the seals, has a ground flat for joining a linear motion device 44 in mechanical communication with the motor shaft by means of, but not limited to a set screw 188. In one embodiment the linear motion device 44 is a lead screw, but should not be restricted to lead screws as other linear motion devices such as ball screws, and linear gears could also be used. The lead screw, unlike screws used as fasteners, is a new cousin to a group of linear motion devices known as “ball screws” but is less expensive, can be made smaller, and much lighter than ball screws. This family of screws has multiple helical starts “threads” that are called leads 124 (hence the name) which spiral down the shaft with an aggressive advance or pitch, similar to that found in gun rifling or drill flutes, for the purpose of converting rotational motion into linear motion, such that one revolution of a lead screw 44 in translational communication with its matching lead screw nut 24 may move its lead screw nut 24 a linear distance along the lead screw 44 a distance that exceeds the diameter of the lead screw 44. Those familiar with the art will further understand that the lead screw nut 24 is usually attached to a movable appliance (in this case coupling 27 and the plunger 21) and prevented from turning and is thus forced to track up and down with translational communication with the leads 124 of the rotating lead screw 44. The lead screw nut 24 has a top and a bottom and low friction leads “threads” (not shown) that mate with the lead screw leads 124 causing the lead screw nut 24 to move in operable dynamic linear translational communication up and down the lead screw 44 in a reciprocating motion determined by the decoys CPU 148 (FIG. 7, to be discussed later). The lead screw nut 24 is prevented from rotating by at least one fence arranged longitudinally inside the bore of the housing 20 (not shown). The lead screw nut 24 travels the linear distance of the lead screw 44 (about 60 mm) in the 0.20 seconds it takes the motor 36 to complete 7 revolutions before it is reversed by the CPU 3 seconds later thus producing brisk linear reciprocating movements with 3 second pauses in between. The brisk motion causes both axial shock to the drivetrain and noise as the lead screw nut 24 reaches the end of travel in each direction. To limit the shock and noise of the lead screw nut 24 upward travel, a first shock absorber 200 is mounted below the seal holder 23, and to limit axial shock and noise at the end of the downward travel of the lead screw nut 24, a second shock absorber 204 is mounted on the lower end of the lead screw nut 24. The shock absorbers 200 and 204 may be made of any suitably compressible rust proof material such as but not limited to rubber and stainless steel springs. The shock absorbers 200 and 204 eliminate axial damage to the motor 36 and also reduce mechanical noise such that the residual noise resembles quiet guttural quacks called “feeding chuckles”. This noise may enhance the decoys luring qualities, but in no way alarums approaching waterfowl. A tubular coupling 27 is in mechanical communication between the lower end of the internal reciprocating lead screw nut 24 and the external plunger assembly 16, 21, 25, and 28. The coupling 27 may be made of rustproof material such as but not limited to stainless steel, brass and anodized aluminum. The tubular coupling 27 is equipped with a plurality of ports 208 and hollow interior to provide water passages for reducing hydrostatic pressure internally within the housing 20 against the motor seals 39 and 40 during reciprocating drivetrain motion, and the bottom 128 of the housing 20 is a spline shaped orifice (not shown) serving the same purpose for reducing pressure against the same said seals. Referring back to FIGS. 4 and 5, a threaded reducer 28 is in mechanical communication with the distal end of coupling 27 and provides a mechanical attachment point for a third rubber shock absorber 25 and a flexible nylon screw 16 that joins the disc shaped plunger 21 to the reducer 28 creating a flexible mechanical weak link between the plunger 21 and the coupling 27. This weak link, comprising 25 and 16, allows the decoy 100 to be stored fully assembled with conventional decoys without damage to the coupling 27 or the drivetrain 112, and eliminates assembly prior to deployment.

Referring now to FIG. 7, the HDPE magazine assembly 31 has a generally hollow waterproof rectangular interior for containing the timing/receiver circuit CPU 148 and a rechargeable power source 45. Referring back to FIG. 4, the magazine assembly 31 is mounted to the posterior bottom surface 132 of the body 5 on a “T” slot structure 104 that mates with the “T” shaped strut 136 on the magazine 31. A waterproof pathway for a plurality of wires is provided between the body 5 and the magazine 31 by a wire conduit 144 that extends upward from the magazine front 140 and is attached to the bottom surface of the body by a watertight plastic weld on the centerline behind the flange 160, but not limited to welds as other means of attachment are possible. The plurality of wires (not shown) are in electrical communication with the blade shaped pressure contacts 42 and the drivetrain motor 36 and in signal communication with contacts 42 and the antenna (not shown) that is arranged generally longitudinally below the dorsal midline of the body, so arranged for good signal communication with a remote transmitter. The plurality of wires may be bedded within the conduit 144 in a sealant such as silicone rubber to prevent water communication between the body 5 and the magazine 31 in the event that watertight integrity in either structure is breached. The removable timing/receiver circuit CPU module 148 is in mechanical, electrical and signal communication with the plurality of blade shaped pressure contacts 42. The CPU 148 has both a timing circuit as a controller for the motor 36 and a receiver circuit that may be, but is not limited to function as an ON/OFF switch to conserve battery power. The CPU 148 has a plurality of front contacts that are in signal and electrical communication with contacts 42 and a rear inclined ramp 152 with a plurality of raised contacts mounted to said ramp that are in mechanical and electrical communication with the power source 45. The CPU 148 is contained in a plastic box that is sealed with a 2 part resin to make said CPU module waterproof. The power source 45 is a 9.6 VDC Nimh rechargeable battery pack with a protection circuit that is contained in a water resistant plastic box. The front of the battery pack has a plurality of recessed contacts that are in electrical and mechanical communication with the raised contacts on the on the CPU ramp 152. The ramp 152 provides a friction fit between the battery contacts and the CPU contacts, and accommodates for contact wear. The rear of the battery box (not shown) is equipped with a lanyard that may be made with but not limited to ribbon and a circular key ring. The said lanyard facilitates battery removal from the magazine 31. The battery box may be brightly colored to prevent loss, and removed for purposes of charging or turning the decoy off. The posterior expandable watertight plug 14, 15, 17, and 22 secures the battery 45 in communication with the CPU 148 and provides a watertight seal at the posterior cylindrical end of the magazine 31. A safety line attached to hole 156 on the plug may be used to prevent loss.

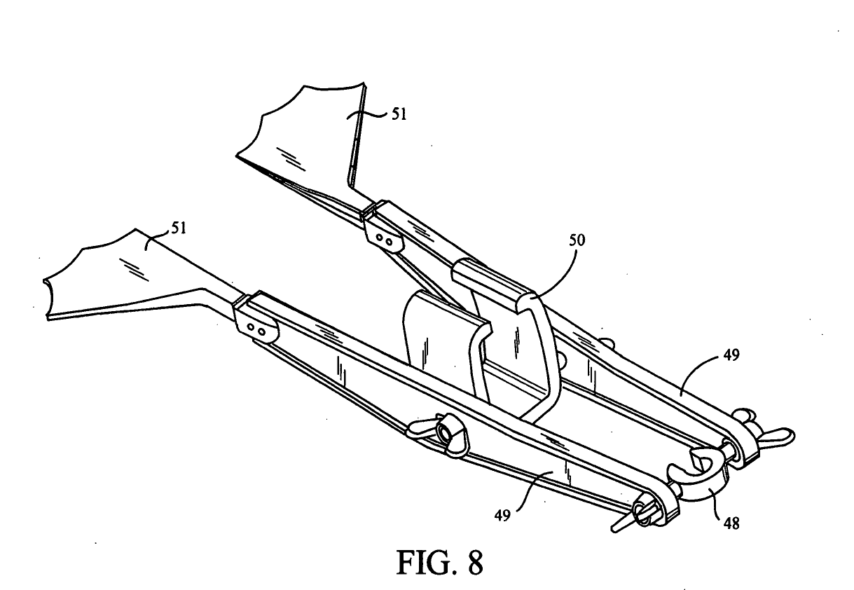

Referring to FIGS. 1 and 8, an optional foot assembly can be added as an additional visual lure. The foot assembly is comprised of a yoke 48 that attaches to the reducer 28 on the lower drivetrain and is in mechanical communication with a plurality of levers 49 that are driven in an up and down by the reciprocating motion of the drivetrain. The levers 49 pivot about a plurality of fulcrums provided by a plurality of axels located on a second yoke 50 that snaps onto the generally central portion of the magazine (not shown). Attached to the rear distal end of the said levers are a plurality of feet 51 that may be brightly colored for visually attracting passing waterfowl. The feet 51 driven by the drivetrain 112 move in an opposite up and down reciprocating motion at and just below the water surface creating ripples that are additional to those produced by the drivetrain 112. The feet 51 may provide meandering locomotion within the scope of the anchor line tether.

Referring back to FIGS. 3, 6, and 7, the programmable timing circuit of the CPU 148 is designed to electrically communicate the battery 45 with the reversible drivetrain motor 36 by energizing the motor 36 for short periods that are sufficiently long to accomplish the full travel of the lead screw nut 24, in translational communication with the lead screw 44, along the full linear length of the lead screw 44, an event that takes about 0.20 seconds. There is then a 3 second resting period before the timing circuit CPU 148 reverses the electric polarity to the drivetrain motor 36 for 0.20 seconds causing the lead screw nut 24 to travel the full length of the lead screw 44 in the opposite direction, again followed by a 3 second resting period. This ON/OFF duty cycle was found to be optimal for both conserving battery life (about 10 hours) and maintaining a highly visible continually expanding wave train; however other duty cycles may be used. The waterfowl decoy 100 was designed without a switch since switches are unreliable and susceptible to introducing water leaks into the body 5 cavity, therefore battery insertion into the magazine 31 followed by the waterproof plug assemble was chosen as the best way to energize the waterfowl decoy 100 just prior to deployment, of course the remote transmitter in signal communication with the CPU 148 receiver circuit, if so provided, can perform but is not limited to the function of a remote ON/OFF switch and can be used to extend battery life by turning the decoy 100 OFF when no waterfowl are present to attract.

Referring back to FIGS. 1-6, in the present embodiment the linear motion drivetrain 112 is in mechanical communication with the reversible electric motor 36 that is in electrical communication with the CPU 148, by this communication pathway the CPU 148 controls the frequency and duration of the drivetrain up and down reciprocations, where the up and down drivetrain reciprocations cause the decoy body 5 to bob at the water surface. Because water is a dense fluid and resists rapid movement of a body through it such as the horizontally positioned disc shaped plunger 21, the plunger 21 is therefore in operative communication with the surrounding water such that it resists movement in the water during the brisk 0.20 second long drivetrain reciprocations, thus mechanically communicating the reciprocating forces of the drivetrain 112 instead to the body 5, causing it to bob up and down at the less dense water surface producing a radiating wave train that is visible to passing waterfowl. In other embodiments the plunger 21 may have other shapes and exert forces against other dense mediums such as but not limited to earthen substrates.

Referring back to FIGS. 3 and 4 shows that the drivetrain 112 is orthogonally arranged below the head 116 in a tower formation. The robust mass of the drivetrain extending into the head region 116 raises the decoy 100 center of mass making it unstable when deployed and bobbing. The internal mass of the magazine 31 and the strut 136 on the magazine 31 were used to lower the decoy center of mass, compensating for the mass of the drivetrain, thus making the decoy 100 stable and self righting. As an added benefit, the robust drivetrain 112 and the submerged magazine 31 are resistant to damage from gunshot pellets.

The waterfowl decoy as described in this embodiment is a unique rugged, waterproof, easy to deploy, floating, waterfowl lure that produces a bobbing motion that radiates a highly visible wave train and mimics a documented duck courtship behavior, representing true waterfowl movement. The radiating wave train also assists in retarding ice formation in the immediate area during freezing weather. Of course the waterfowl decoy could be deployed on a terrestrial surface, absent water and ripples, wherein the bobbing motion would still mimic an element of courtship behavior and serve as a waterfowl lure.

The novel design of this device required the engineering and manufacture of all parts, except hardware such as fasteners and O-rings, and are unique only to this device.

It should be noted that the terms “first”, “second”, and “third” and the like may be used herein to modify elements performing similar and/or analogous functions. These modifiers do not imply a spatial, sequential, or hierarchical order to the modified elements unless specifically stated.

While the disclosure has been described with references to several embodiments, it will be understood by those skilled in the art that various changes may be made and equivalents may be substituted for elements thereof without departing from the scope of the disclosure. In addition, many modifications may be made to adapt a particular situation or material to the teachings of this disclosure without departing from the essential scope thereof. Therefore, it is intended that the disclosure not be limited to the particular embodiments disclosed as the best mode contemplated for carrying out this disclosure, but that the disclosure will include all embodiments falling within the spirit and scope of the appended claims.

What is claimed is:

1. A mechanical decoy apparatus for attracting waterfowl comprising:
a water tight waterfowl body;
an up and down vertically reciprocating linear motion producing drivetrain connected to said waterfowl body;
a plunger in mechanical communication with a dense medium and with said drivetrain for communicating said up and down vertically reciprocating motion to said body;
an electronic central processing unit plug in module (CPU), comprising both a timing circuit and a receiver circuit, contained in a water tight plastic magazine attached external to said body, for controlling said drivetrain connected to said body;
a rechargeable power supply in electrical communication with said CPU, said power supply providing power to both said CPU and said drivetrain;
a molded plastic water tight magazine mounted external to said body for containing said CPU and said power supply.

2. The mechanical decoy apparatus for attracting waterfowl as described in claim 1, wherein said waterfowl body comprises a one piece watertight molded plastic body, said waterfowl body having a head and neck region, a front perimeter, a hollow interior, and a bottom surface with water tight attachment points for said drivetrain and said magazine.

3. The mechanical decoy apparatus for attracting waterfowl as described in claim 1, wherein said drivetrain is mounted orthogonally, by means of a water tight flange, to the bottom surface of said waterfowl body on the midline below the head and neck region;
Wherein said up and down vertically reciprocating linear motion of said drivetrain is produced by a linear motion lead screw nut that converts the rotational motion of a rotating lead screw, powered by a reversible electric motor, to produce linear motion in said lead screw nut by said lead screw nut moving in reversible reciprocating dynamic translational linear communication longitudinally along the leads (a plurality of threads also called “starts”) of said lead screw.

4. The mechanical decoy apparatus for attracting waterfowl as described in claim 1, wherein said plunger is a structure in mechanical communication with said vertically reciprocating linear motion drivetrain and in mechanical communication with a dense medium that transfers the friction acting against said dense medium through the vertically reciprocating linear motion forces of said drivetrain and said plunger against said dense medium to said waterfowl body in a less dense medium that is in mechanical communication with said drivetrain;
Wherein said structure of said plunger in the present embodiment comprises a flat disc shaped structure acting against the dense medium of water (however in other embodiments, it should be understood that said plunger may comprise other structures that may be suitable for transferring said vertically reciprocating linear motion forces against other terrestrial substrates.).

5. The mechanical decoy apparatus for attracting waterfowl as described in claim 1, wherein said CPU, having a front end and a rear end, is a modular plug in timing/receiver circuit device sealed in a water tight box with two part resin, further comprising:
a plurality of pressure contacts and wires at said front end for electrical communication inside the waterfowl body with a reversible electric motor on said drivetrain and in signal communication with an antenna located in the hollow body interior;
a plurality of raised pressure contacts on an inclined surface at said rear end of said CPU in electrical communication with a plug in power supply, the inclined surface providing a friction fit that allows for contact wear between said CPU said power supply;
a timing circuit for energizing said electric motor with an ON/OFF duty cycle;
a duty cycle with said ON time long enough for powering a full single direction travel of the linear lead screw nut along the full length of the lead screw for each ON electrical signal it send to the drivetrain motor;
a duty cycle with a said OFF time of sufficient length to conserve battery life, yet is short enough between said ON times to maintain a highly visible expanding wave pattern without holidays that is produced by the bobbing waterfowl decoy;
a receiver circuit in signal communication with a remote transmitter for electrical communication with said timing circuit.

6. The mechanical decoy apparatus as described in claim 1, wherein said rechargeable power supply has a front end, a rear end comprising, and a hollow interior:
a plastic water resistant box;
a 9.6V DC Nimh rechargeable battery pack located within said hollow interior said box
a circuit protecting against accidental discharge located within said hollow interior of said box;
a plurality of recessed contacts on the front end of said box that are in mechanical and electrical communication with said raised inclined pressure contacts at rear of said CPU;
a lanyard on the rear end of said box for extracting said rechargeable power supply from said molded plastic water tight magazine.

7. The mechanical decoy apparatus for attracting waterfowl as described in claim 1, wherein said CPU and said power supply are contained within the water tight volume of said molded plastic water tight magazine attached externally to the bottom surface of said waterfowl body, with said CPU in electrical communication with said drivetrain and in signal communication with the antenna located within the hollow interior of said waterfowl body by a plurality of wires routed through a water tight wire conduit joining said magazine to said waterfowl body bottom.

8. The mechanical decoy apparatus for attracting waterfowl as described in claim 1, further comprising:
a remote transmitter, which in this embodiment functions as a remote ON/OFF switch;
wherein said transmitter is in signal communication with the antenna located longitudinally on the dorsal mid-line within the hollow interior of said waterfowl body, and said antenna is in signal communication, via said magazine wire conduit, with said receiver circuit within said CPU.

9. The mechanical decoy apparatus for attracting waterfowl as described in claim 1, further comprising:
a pair of feet that move up and down at the water surface attached to levers that are connected to a fulcrum attached centrally to the plastic magazine and joined to a yoke in mechanical communication with the lower drivetrain coupling.

10. A method for attracting waterfowl to a desired location by motion comprising:
a said up and down vertically reciprocating motion produced by said plunger in mechanical communication with said drivetrain and said waterfowl body, producing forces against a dense medium, the friction of said forces causing said body to move vertically up and down with a bobbing motion in a less dense medium;
a highly visible said bobbing motion that functions as a waterfowl lure by mimicking a documented courtship behavior observed in duck species, both on land and in water, immediately prior to copulation;
a said bobbing motion produced by said waterfowl decoy at the water surface that further attracts waterfowl by producing a continually expanding wave train on the water surface that is highly visible and imparts motion to nearby conventional non mechanical decoys at the water surface, wherein said waves and said motion are effective waterfowl lures.

11. A mechanical decoy apparatus for attracting waterfowl to a desired location comprising:
a one piece molded water tight plastic body with a head and neck region, a front perimeter, a hollow interior, and a bottom surface;
an electrically powered mechanical linear motion producing drivetrain attached to said bottom surface of said plastic body for producing a bobbing motion of said plastic body at the water surface;
a water tight plastic magazine mounted to said bottom surface of said plastic body with an interior volume for containing a timing/receiver circuit module and power supply for controlling and powering said linear motion producing drivetrain.

12. The mechanical decoy apparatus as described in claim 11, the body further comprising:
a bottom surface with a front end and a rear end;
a hole below said head and neck region on the front end of said bottom surface surrounded by a circular arrangement of blind fasteners molded into said plastic body comprising a flange for mounting said drivetrain to said plastic body with a water tight joint;
a “T” shaped slot molded into the said rear end of said bottom surface of said plastic body on the midline of said bottom surface for mounting the magazine to said plastic body;
a hole on the centerline of said bottom surface of said plastic body immediately forward of said “T” slot terminus for joining the wire conduit on said plastic magazine to said plastic body with a water tight joint.

13. The mechanical decoy apparatus as described in claim 11, the electrically powered mechanical linear motion drivetrain comprising:
a reversable electric DC motor in electrical communication through a plurality of wires with said CPU located in said plastic water tight magazine;
a molded plastic drivetrain housing having a top flange, a bottom end, and a hollow interior, a motor mounted to said top flange, a plurality of seals within said top flange, a capsule and sealing O-ring that may be oil filled covering said top flange and said motor isolating said motor from water which may enter the hollow interior volume of the plastic body, a motor shaft that penetrates a plurality of seals and extends into said hollow interior of said housing with the interior of said housing being open to the surrounding environment, a linear motion lead screw attached in mechanical communication with the distal end of said motor shaft, a plurality of starts arranged in a helical formation called “leads” that extend along the length of said lead screw, a lead screw nut that converts the rotational motion of said lead screw to linear motion of said lead screw nut by said lead screw nut tracking on said lead screw leads in dynamic operative reciprocating communication with the rotationally reciprocating said lead screw which briskly drives said lead screw nut in alternate directions along the length of said lead screw, a plurality of shock absorbers mounted at each end of the linear travel of said lead screw nut to dampen noise and axial shock to said motor, a tubular coupling with a proximal end a distal end and a plurality of vented ports to reduce hydrostatic pressure within said molded plastic drivetrain housing with said proximal end of said coupling in mechanical communication with said lead screw nut and said distal end of said coupling exiting said molded plastic drivetrain housing bottom end, a spline shaped orifice on said plastic drivetrain housing bottom end that further reduces internal hydrostatic pressure within said plastic drivetrain housing through which said distal end of said coupling exits said plastic drivetrain housing, a threaded portion on the exterior surface of said bottom end of said plastic drivetrain housing, a threaded flange and O-ring attached to said threaded exterior surface for attachment to said plastic body bottom with a plurality of screws and a gasket to form a water tight joint between the bottom surface of said plastic body and said drivetrain, an anchor line cleat and retaining nut attached to said threaded exterior surface of said plastic drivetrain housing, a threaded reducer in mechanical communication with the said distal end of said tubular coupling, a flexible shock absorber in mechanical communication with said reducer and a plunger, and a plunger in mechanical communication with a dense medium.

14. The mechanical decoy as described in claim 11, the water tight plastic magazine further comprising:
a strut having a top, a bottom, a front and a rear, a “T” shaped structure at the top of said strut for attachment to the “T” shaped slot located on the posterior bottom mid line of said plastic body, a hole at the rear of said strut for attachment of a safety line to a water tight expandable plug for sealing said plastic magazine, a generally longitudinal rectangular plastic magazine attached to the bottom of said strut separating said plastic magazine and its mass from said plastic body for providing a lower center of mass for said mechanical decoy, a water tight wire conduit at the front end of said strut for providing a water tight pathway between said magazine and said plastic body for a plurality of wires;
a generally longitudinal rectangular plastic magazine having a front end, a rear end, a top, and an interior volume, a plurality of pressure contacts at said front end for electrical and signal communication of the timing/receiver circuit module with said plurality of wires, a wire conduit at the top front end of said plastic magazine welded to said plastic body bottom that provides a water tight pathway for a plurality of said wires from the water tight interior volume of said magazine to the water tight interior volume of said plastic body, a generally longitudinal rectangular interior volume within said magazine for positioning said timing/receiver circuit module in electrical communication with said front pressure contacts and positioning said rechargeable power supply in said rear end of said plastic magazine in electrical communication with said timing/receiver circuit module, a round interior surface at the rear end of said generally rectangular plastic magazine for providing a sealing surface for a round expandable water tight plug for making said interior volume of said plastic magazine water tight;
a round expandable water tight plug for positioning at said rear round interior surface of said plastic magazine for providing a water tight seal to said rectangular interior volume of said plastic magazine by means of a rubber doughnut that is sandwiched between a pair of washers joined together by a bolt with a nut such that when the nut is tightened the expanding rubber doughnut seals said rear round interior surface with a water tight seal;
a safety line between said water tight plug and said magazine to prevent loss of said watertight plug.

15. The mechanical decoy as described in claim 11, further comprising:
a pair of yokes
a pair of brightly colored feet;
a pair of levers having a front, middle, and rear;
a fulcrum;
a first yoke connected to and in mechanical communication with the lower drivetrain reducer and said front of said pair of levers, the said middle of said pair of levers pivoting about said fulcrum attached generally to the middle of the plastic magazine by means of a second yoke, the said pair of highly visible brightly colored feet attached, one each, to said rear of said pair of levers, said feet moving in a generally up and down reciprocating motion at and under the water surface, powered by said drivetrain reciprocations, the reciprocation of said pair of brightly colored feet causing ripples at the water surface that provide a lure to waterfowl.
